(19) United States
(12) Patent Application Publication
(10) Pub. No.: US 2019/0178668 A1
(43) Pub. Date: Jun. 13, 2019

(54) INFORMATION PROVIDING DEVICE AND INFORMATION PROVIDING METHOD

(71) Applicant: Toyota Jidosha Kabushiki Kaisha, Toyota-shi (JP)

(72) Inventors: Hiroshi Nishimura, Anjo-shi (JP); Takashi Goto, Okazaki-shi (JP)

(73) Assignee: Toyota Jidosha Kabushiki Kaisha, Toyota-shi (JP)

(21) Appl. No.: 16/209,383

(22) Filed: Dec. 4, 2018

(30) Foreign Application Priority Data
Dec. 11, 2017 (JP) 2017-236905

(51) Int. Cl. G01C 21/34; G01S 13/88; G01S 13/58

(52) U.S. Cl. CPC G01C 21/3492; G01S 13/58; G01S 13/88

(57) ABSTRACT

All information providing device includes an acquisition unit configured to acquire radio wave information indicating a radio-wave receiving sensitivity on a route; and a processor configured to estimate, in consideration of the radio wave information, a decrease time during which a movable body moves on a first route where the radio-wave receiving sensitivity is decreased, and to store, prior to the decrease time, data in an amount that allows contents of the data to be continuously output at least during the decrease time.

### CROSS-REFERENCE TO RELATED APPLICATIONS

This application claims priority to Japanese Patent Application No. 2017-236905 filed on Dec. 11, 2017, which is incorporated herein by reference in its entirety including the specification, drawings and abstract.

### BACKGROUND

### 1. Technical Field

The disclosure relates to an information providing device and an information providing method.

### 2. Description of Related Art

Japanese Patent Application Publication No. 2017-41774 (JP 2017-41774 A) describes an information processing device that includes reception means for receiving data on at least a part of a video from an image transmission device, reproduction means for sequentially reproducing the data received by the reception means, accumulation means for accumulating the data that has been received by the reception means and that has not been reproduced by the reproduction means until the amount of data reaches a predetermined amount, and change means for changing the predetermined amount. The change means changes the predetermined amount in accordance with a communication environment between the image transmission device and the reception means, and user's video viewing habits or information on the video.

### SUMMARY

However, a server that delivers a sound and the video may not consider whether the information processing device that requests the delivery of the sound and video is mounted in a movable body or fixed. Further, the information processing device described in JP 2017-41774 A does not consider a radio-wave receiving sensitivity (i.e., an electric-wave receiving sensitivity) on a route where the movable body moves (i.e., travels). Therefore, when the movable body moves on a route where the radio-wave receiving sensitivity is low, for example, in a tunnel, the sound and video that are delivered and output may be interrupted. Furthermore, there are a large number of structures that decrease the radio-wave receiving sensitivity. Thus, it is greatly desired to solve the problem.

Thus, the disclosure provides an information providing device and an information providing method that make it possible to output a delivered sound and delivered video without interruption even in the case where the radio-wave receiving sensitivity is low on a route where a movable body moves.

A first aspect of the disclosure relates to an information providing device including an acquisition unit configured to acquire radio wave information indicating a radio-wave receiving sensitivity on a route; and a processor configured to estimate, in consideration of the radio wave information, a decrease time during which a movable body moves on a first route where the radio-wave receiving sensitivity is decreased, and to store, prior to the decrease time, data in an amount that allows contents of the data to be continuously output at least during the decrease time.

A second aspect of the disclosure relates to an information providing method including acquiring radio wave information indicating a radio-wave receiving sensitivity on a route; estimating, in consideration of the radio wave information, a decrease time during which a movable body moves on a first route where the radio-wave receiving sensitivity is decreased; and storing, prior to the decrease time, data in an amount that allows contents of the data to be continuously output at least during the decrease time.

According to the above-described aspects of the disclosure, it is possible to provide the information providing device and the information providing method that make it possible to output the delivered sound and the delivered video without interruption even in the case where the radio-wave receiving sensitivity is low on the route where the movable body moves.

### BRIEF DESCRIPTION OF THE DRAWINGS

Features, advantages, and technical and industrial significance of an exemplary embodiment of the disclosure will be described below with reference to the accompanying drawings, in which like numerals denote like elements, and wherein:

FIG. 1 is a view showing an example of a configuration of an information providing device according to an embodiment; and

FIG. 2 is a flowchart showing an example of a process that is performed by the information providing device according to the embodiment.

### DETAILED DESCRIPTION OF EMBODIMENT

An embodiment of the disclosure will be described with reference to the accompanying drawings. Any elements that are denoted by the same reference numeral have the same or similar configuration in each of the drawings.

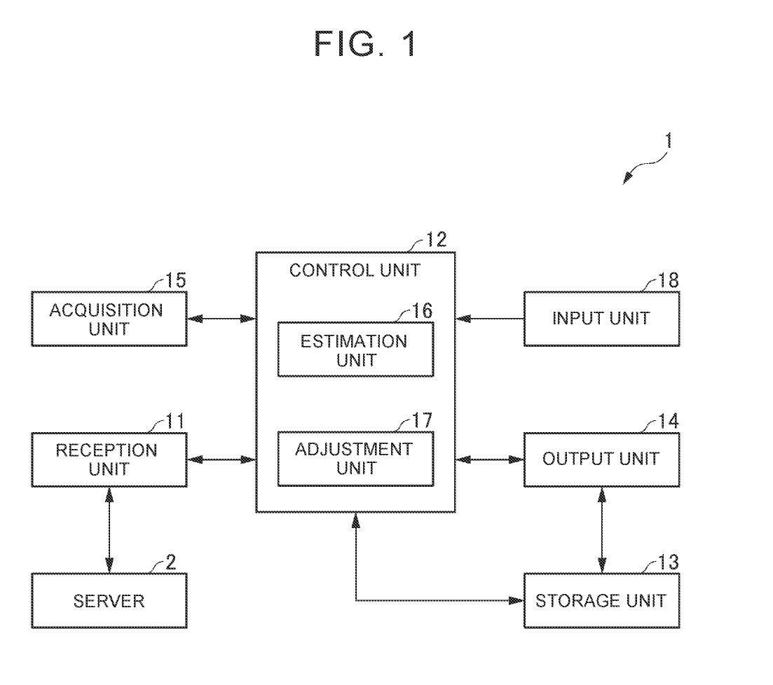

The configuration of an information providing device according to the embodiment will be described with reference to FIG. 1. As shown in FIG. 1, an information providing device 1 includes a reception unit 11, a control unit 12, a storage unit 13, an output unit 14, an acquisition unit 15, an estimation unit 16, an adjustment unit 17, and an input unit 18. The information providing device 1 includes at least the acquisition unit 35, the estimation unit 16, and the adjustment unit 17. Other devices having similar functions may be used instead of the reception unit 11, the control unit 12, the storage unit 13, the output unit 14, and the input unit 18. Furthermore, the information providing device 1 may include components other than those shown in FIG. 1.

The reception unit 11 is, for example, a dedicated communication device (a data communication module (a DCM)), and includes, for example, a communication module and a central processing unit (a CPU) that controls this communication module. The reception unit 11 receives sound data and video data (i.e., motion picture data) from a server 2 shown in FIG. 1, stores the data into the storage unit 13 via the control unit 12, and transmits the data to the output unit 14 via the control unit 12. The sound data are data as a source of a sound output from the output unit 14, for example, analog data as a source of a sound of an Internet radio for connected cars. The video data are data as a source of a video output from the output unit 14, for example, analog data as a source of a video delivered by a video delivery service. The reception unit 11 requests the server 2 to deliver the sound data and/or the video data in accordance with a request from the adjustment unit 17, and receives the data from the server 2.

The control unit 12 is, for example, a CPU. The control unit 12 transmits signals to the reception unit 11, the storage unit 13, the output unit 14, the acquisition unit 15, the estimation unit 16, the adjustment unit 17, and the input unit 18 to perform control, and processes signals received from the units.

The storage unit 13 is, for example, a random access memory (a RAM) or a static random access memory (an SRAM). Sound data and video data are stored in the storage unit 13.

The output unit 14 outputs at least one of a sound of the contents indicated by the sound data, and a video of the contents indicated by the video data. The output unit 14 includes, for example, an analog-to-digital conversion circuit (an analog-to-digital converter (an ADC)), a digital signal processor (a DSP), a digital-to-analog conversion circuit (a digital-to-analog convener (a DAC)), an amplifier, a speaker, and a display. The output unit 14 acquires the sound data and the video data from the storage unit 13, converts the data into digital data with the use of the ADC, performs digital signal processing on the digital data with the use of the DSP, converts the digital data into analog data with the use of the DAC, and amplifies the analog data with the use of the amplifier. Then, the output unit 14 outputs at least one of a sound and a video. A sound is output with the use of the speaker. A video is output with the use of the display.

The acquisition unit 15 acquires radio wave information indicating a radio-wave receiving sensitivity (i.e., a receiving sensitivity for radio waves) on a route. The acquisition unit 15 acquires a current position of a movable body, information on the movable body, and route information on the route where the movable body moves (i.e., travels). The movable body is, for example, an automobile (a vehicle), a train, or a bullet train. The information on the movable body is information including a speed of the movable body and a moving direction (i.e., a traveling direction) of the movable body. The route is, for example, an ordinary road, a freeway, or a railway. The route information includes traffic congestion information indicating situations on the route such as accidents, road closure, traffic regulation, and traffic congestion, and may include, for example, a link travel time and a zone travel time. The link travel time is a time required for passing through a VICS link as a certain zone such as an interval between intersections on the route. The zone travel time is a time required for reaching a specific spot. The current position of the movable body may be acquired by a global positioning system (GPS) receiver.

The above-described pieces of information are appropriately updated, acquired from, for example, the Vehicle Information and Communication System (VICS (Registered Trademark)), and displayed by a car navigation system that is mounted in the movable body.

The estimation unit 16 estimates, in consideration of the radio wave information, a decrease time during which the movable body moves on a route (a first route according to the disclosure) where the radio-wave receiving sensitivity is decreased. The decrease time is, for example, a time period from a time when the movable body starts moving on the route where the radio-wave receiving sensitivity is decreased to a time when the movable body finishes moving on the route where the radio-wave receiving sensitivity is decreased. The route where the radio-wave receiving sensitivity is decreased is, for example, a tunnel. The estimation unit 16 may estimate the decrease time in consideration of the traffic congestion information. Furthermore, the estimation unit 16 may estimate the decrease time by dividing the length of the mute where the radio-wave receiving sensitivity is decreased by the speed of the movable body that moves on the route. In this case, for example, the estimation unit 16 estimates the decrease time by dividing the length of the tunnel where the movable body moves by the speed of the movable body. The estimation unit 16 may nor be included in the control unit 12, or may be included in the control unit 12 as shown in FIG. 1.

Prior to the decrease time, the adjustment unit 17 stores, in the storage unit 13, data in an amount that allows the contents of the dam to be continuously output at least during the decrease time. For example, in the case where the decrease time is five minutes from 9:05 to 9:10, the adjustment unit 17 requests, prior to 9:05, the reception unit 11 to receive, from the server 2, data in an amount that allows the output unit 14 to continuously output a sound and/or a video even when the reception unit 11 cannot receive the data, at least during the decrease time. Then, the adjustment unit 17 receives this amount of data from the reception unit 11, and stores the data into the storage unit 13. The adjustment unit 17 may not be included in the control unit 12, or may be included in the control unit 12 as shown in FIG. 1.

The input unit 18 is a human-machine interface (an HMI) that is used when a user of the information providing device 1 inputs commands and settings, and is, for example, a button or a switch.

The server 2 delivers sound data and video data. The server 2 can determine the speed and the moving direction (i.e., the traveling direction) of the information providing device 1, and delivers a necessary amount of data to the reception unit 11 in accordance with a request from the reception unit 11.

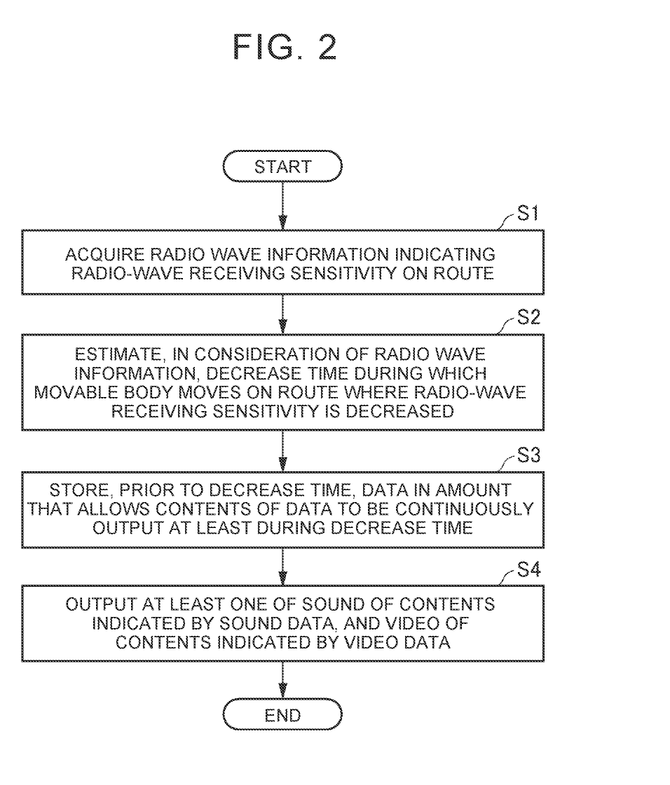

An example of a process that is performed by the information providing device 1 according to the embodiment will be described with reference to FIG. 2.

In step S1, the acquisition unit 15 acquires radio wave information indicating a radio-wave receiving sensitivity on the road. In step S1, the acquisition unit 15 may acquire a current position of the movable body, information on the movable body, and route information on the route where the movable body moves.

In step S2, the estimation unit 16 estimates, in consideration of the radio wave information, a decrease time during which the movable body moves on the route where the radio-wave receiving sensitivity is decreased. In step S2, the estimation unit 16 may estimate the decrease time in consideration of the traffic congestion information.

In step S3, prior to the decrease time, the adjustment unit 17 stores, in the storage unit 13, data in an amount that allows the contents of the data to be continuously output at least during the decrease time.

In step S4, the output unit 14 outputs at least one of a sound of contents indicated by sound data, and a video of contents indicated by video data.

The embodiment as an example of the disclosure has been described above. The information providing device 1 according to the embodiment includes the acquisition unit 15 that acquires radio wave information indicating the radio-wave receiving sensitivity on the route, the estimation unit 16 (i.e., a processor according to the disclosure) that estimates, in consideration of the radio wave information, the decrease time during which the movable body moves on the route (i.e., the first route according to the disclosure) where the radio-wave receiving sensitivity is decreased, and the adjustment unit 17 (i.e., the processor according to the disclosure) that stores, prior to the decrease time, data in an amount that allows the contents of the data to be continuously output at least during the decrease time. Therefore, the information providing device 1 can output the delivered sound and the delivered video without interruption, even in the case where the radio-wave receiving sensitivity is low on the route where the movable body moves.

The network environment for the Internet radio is maintained by short-range communication networks such as cellular phone networks, and WiFi. Furthermore, when the movable body moves at high speed, it may be difficult to receive the sound data of the Internet radio via the short-range communication networks such as WiFi. Therefore, the information providing device 1 is particularly useful in the case where the movable body receives the services of the Internet radio for connected cars.

The disclosure is not limited to the above-mentioned embodiment, and may be implemented in various embodiments without departing from the scope of the disclosure. Therefore, the above-mentioned embodiment is merely an example, and should not be interpreted in a restrictive manner. For example, the above-mentioned processing steps may be performed in an order different from the order of the processing steps in the above-described embodiment, or may be performed in parallel as long as contents of the processing steps are not contradictory to each oilier.

What is claimed is:

1. An information providing device comprising:
an acquisition unit configured to acquire radio wave information indicating a radio-wave receiving sensitivity on a route; and
a processor configured to estimate, in consideration of the radio wave information, a decrease time during which a movable body moves on a first route where the radio-wave receiving sensitivity is decreased, and to store, prior to the decrease time, data in an amount that allows contents of the data to be continuously output at least during the decrease time.

2. The information providing device according to claim 1, wherein:
the acquisition unit is configured to further acquire traffic congestion information indicating a traffic congestion situation on the route where the movable body moves; and
the processor is configured to estimate the decrease time in consideration of the radio wave information and the traffic congestion information.

3. The information providing device according to claim 1, wherein the processor is configured to estimate the decrease time by dividing a length of the first route where the radio-wave receiving sensitivity is decreased by a speed of the movable body that moves on the first route.

4. An information providing method comprising:
acquiring radio wave information indicating a radio-wave receiving sensitivity on a route;
estimating, in consideration of the radio wave information, a decrease time during which a movable body moves on a first route where the radio-wave receiving sensitivity is decreased; and
storing, prior to the decrease time, data in an amount that allows cements of the data to be continuously output at least during the decrease time.
